(19) United States
(12) Patent Application Publication
(10) Pub. No.: US 2010/0010897 A1
(43) Pub. Date: Jan. 14, 2010

(54) Method, Apparatus and System for Calculating and Displaying an Influence Map Using Adjacencies between Discontinuous Geographies

(76) Inventor: Robert Tyler, London (GB)

Correspondence Address: STATTLER - SUH PC, 60 SOUTH MARKET STREET, SUITE 480, SAN JOSE, CA, 95113, US

(21) Appl. No.: 12/172,957

(22) Filed: Jul. 14, 2008

(51) Int. Cl. G06Q 30/00

(52) U.S. Cl. 705/14.58

(57) ABSTRACT

A system for presenting on-line advertising for goods and services to a user. After determining a geographic location of interest the method runs a query for retrieving candidate advertisements based on geographic location of interest, an advertiser type, and values in an influence map. The influence map is constructed by overlaying geographic location data onto an XY grid of cells and dividing cells into sub-cells that approximate various political or natural boundaries or other devised degrees of separation. Influences from geographically defined locations are propagated iteratively to neighboring cells, thus providing a continuous metric for influence across discontinuous geographic boundaries. Having now a measure of influence of a particular geographic feature and a user's suggestion of desired goods and/or services, advertisements are presented to the user in form of an ordered list, or in a web page frame, or on a geographic- or influence-oriented map.

### BACKGROUND OF THE INVENTION

1. Field of the Invention

The present invention is directed toward the field of online searching, and more particularly toward an online matching system.

2. Art Background

The Internet provides a mechanism for merchants to offer a vast range of products and services to consumers. One problem in managing such a vast range of products and services is matching a user's search query with availability of products and services that correspond to a particular geography. For example, a buyer looking to buy a book might not care where the bookseller is located, so long as other characteristics of the transaction are favorable (e.g. total price, delivery date). In contrast, a user looking to find (for example) an automobile service station for an oil change service might consider the search results pertaining to automobile service stations within the same city to be more relevant than any other search results.

Various means to map or transform geographies into computer-readable representations have been attempted; however, there are many problems with such attempts. In particular, as the granularity of the mapping increases (together with relevance), the computing resource requirements to create and maintain computer-readable representations also increases. Also, as new features of the geographies (e.g. a newly incorporated town, or a new area to be serviced) are added or deleted, the computer-readable representations must be changed correspondingly, resulting in still more computing resource requirements. It is these and other limitations of such prior attempts that motivate the present invention disclosed herein.

### SUMMARY OF THE INVENTION

After determining a geographic location of interest the method runs a query for retrieving candidate advertisements based on geographic location of interest, an advertiser type, and values in an influence map. The influence map is constructed by overlaying geographic location data onto an XY grid of cells and dividing cells into sub-cells that approximate various political or natural boundaries or other devised degrees of separation. Influences from geographically defined locations are propagated iteratively to neighboring cells, thus providing a continuous metric for influence across discontinuous geographic boundaries. Having now a measure of influence of a particular geographic feature and a user's suggestion of desired goods and/or services, advertisements are presented to the user in the form of an ordered list, or in a web page frame, or on a geographic- or influence-oriented map.

### BRIEF DESCRIPTION OF THE DRAWINGS

FIG. 1A is a depiction of a grid formed into a Cartesian coordinate system.

FIG. 1B is a depiction of a geography overlaid on a Cartesian coordinate grid.

FIG. 2A is magnified area of a grid, showing cells, a political boundary and a river, according to one embodiment.

FIG. 2B is a magnified area of a grid, showing how cells might be split around a political boundary and a river, according to one embodiment.

FIG. 3 is a magnified area of a grid showing a possible technique for cell identification, according to one embodiment.

FIG. 4 is a magnified area of a grid showing several cells assigned to the center of an influence, according to one embodiment.

FIG. 5A is a magnified area of a grid showing all cells in the area assigned values according to one or more possible influences, according to one embodiment.

FIG. 5B is a magnified area of a grid showing all cells in the area assigned values according to exactly one influence, according to one embodiment.

FIG. 5C is a magnified area of a grid showing the borders of influences, according to one embodiment.

FIG. 6 is a magnified area of a grid showing all cells in the area assigned values according to exactly one influence, and showing selected political and geographic features, according to one embodiment.

FIG. 7A is a magnified area of a grid showing all cells in the area assigned values according to one or more possible influences when adding a new influence, and showing selected political and geographic features, according to one embodiment.

FIG. 7B is a magnified area of a grid showing all cells in the area assigned values according to exactly one influence after adding a new influence, and showing selected political and geographic features, according to one embodiment.

FIG. 8 is a process flow diagram that illustrates the steps associated with a method of calculating an influence map using adjacencies between discontinuous geographies, according to one embodiment.

FIG. 9 is a process flow diagram which illustrates the steps associated with a method of calculating an influence map using adjacencies between discontinuous geographies, according to one embodiment.

FIG. 10 is a process flow diagram which illustrates the steps associated with a method of calculating an influence map using adjacencies between discontinuous geographies, according to one embodiment.

FIG. 11 is a network diagram which illustrates a possible computing environment associated with a method of calculating an influence map using adjacencies between discontinuous geographies, according to one embodiment.

### DETAILED DESCRIPTION

### Overview:

The vastness of information available via the World Wide Web presents special problems and opportunities for online advertisers. Given a choice, buyers often prefer to shop locally (e.g. within a particular city, or within a particular sub-urban area, or within a particular country). Enterprises often want to target buyers holding such a preference as those buyers are likely to be repeat buyers. By converting the discontinuous geography of city areas and points into a seamless digital map abstract, the present invention enables the enterprise to improve both the ability to serve relevant on-line advertising to suburban locations, as well as to improve the accuracy of expanding the geographical reach of on-line advertisements via association to proximate or other geographically associated locations.

The invention described herein includes techniques for production of a seamless digital map that propagates the extents of city limits using distance and relative importance as criteria. Such propagation can thus cover 100% of a geographic area.

In broad terms, a computer-readable representation of a seamless digital map is produced by (1) creating a grid with divisions sized appropriately to create a two-dimensional array of cells; (2) overlaying a geography onto the array of cells; and (3) populating each cell with attribute information, namely pre-defined attributes (e.g. city name, latitude/longitude, country name), or calculated attributes (e.g. distance from city center) corresponding to the overlaid geography or any other value or values that permit relative importance to be determined.

A given cell might be located more-or-less equidistant from two or more cities. In such a case one or more techniques should be employed to appropriately “break the tie” and assign attribute values to the cell that corresponds to attributes of stronger influence on that given cell. Using such techniques, each and every cell that is overlaid with the attributes of one or more influences (e.g. known political boundaries, street geography, special interest point, etc) can be thusly populated.

From the above description, it can be seen that at some early stage in the production of a seamless digital map there are cells containing no assignment of attribute values. The invention herein discloses techniques for propagating geographic influences by assigning attribute values to unassigned cells. Such techniques overcome limitations of previous attempts in that the techniques disclosed herein allow influences to propagate beyond or across selected political or administrative boundaries (e.g. county and state lines, other hierarchical limits) while concurrently and selectively limiting propagation only within other selected hierarchical political or administrative boundaries. Moreover, application of the techniques disclosed herein facilitate recalculation after modifications have been made to the overlaid geographic data, resulting in improvements to the speed of recalculation and thus enhancing the accuracy and maintainability of the computer-readable seamless digital map.

Now, with a general understanding of the nature of the desired computer-readable seamless digital map, we can turn our attention to the various specific techniques used and combined in the production of the seamless digital map.

### Creating a Grid for the Influence Map

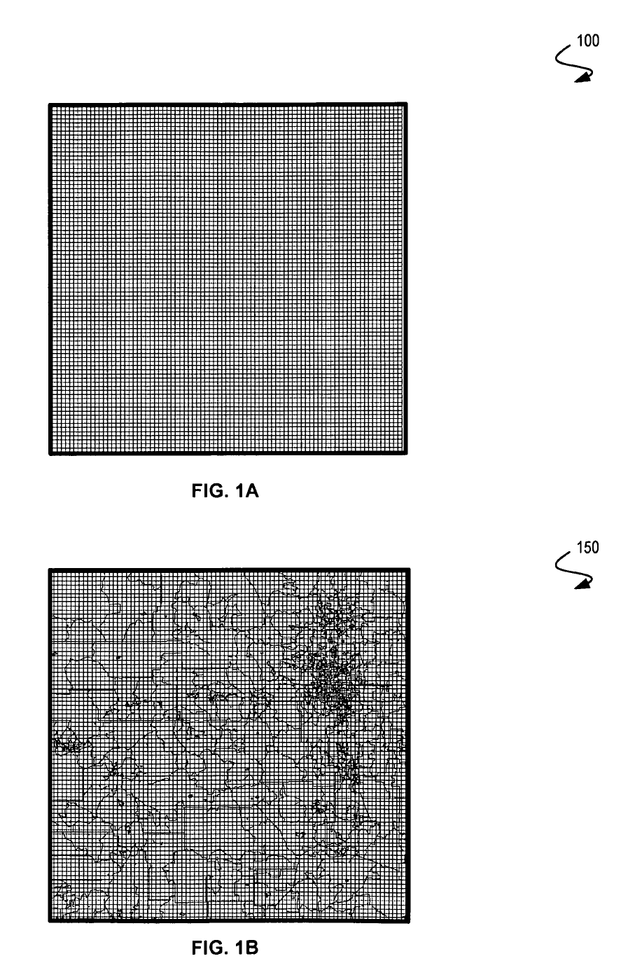

FIG. 1A depicts an XY grid 100 which is represented in a computer readable form, for example, as an array of cells. FIG. 1B depicts the overlay 150 comprised of a geographic map overlaid on the grid.

As shown the grid 100 of FIG. 1A is a strict Cartesian coordinate plot having divisions units of a given size (e.g. distance) D assigned to each of the horizontal (X) and vertical (Y) axes, resulting in a grid of X*Y cells. This assignment of equally dimensioned divisions of D units to the two axes results in a grid consisting of square cells, each representing an area of D² units. However, in various embodiments, the grid might be divided using different divisions for each axis, thus producing a rectangular cell. Moreover, the two-dimensional grid can be interpreted as merely a two-dimensional projection of a multi-dimensional array of cells, with dimension Z (or other dimensions) representing any arbitrary attribute. The grid might be conveniently represented for computer readability as a two-dimensional array, however the group of cells might be represented in some other form such as a linked list, or a set, or any other representation for that matter as may be selected by the implementers. A grid 100 is defined to cover the area of the geography being mapped. The assignment of the distance D to one or both axes is a matter for optimization. A smaller distance assignment (e.g. hundreds or thousands of feet) has the advantage of a higher degree of accuracy while then requiring more computing resources to create and maintain the array. Conversely, a larger distance assignment (e.g. thousands of feet or miles) has the advantage of requiring fewer computing resources to create and maintain the array—at the tradeoff of accuracy.

Of course the aforementioned grid is typically implemented as an array; however, for purposes of presentation on paper or on a computer display, the grid can be thought of as a contiguous area of closed path polygons. Again, for purposes of presentation on paper or on a computer display, the area covered by the grid might be stretched, for example, as in a Mercator projection so as to map a non-flat (e.g. spherical) surface area onto a flat presentation surface. Further, each polygon can be thought of as a cell, containing zero or more attributes. Each cell, even though inherently addressable via Cartesian coordinates, might be given a unique cell identification, typically an integer value. In various embodiments discussed here, the terms cell, grid element, and array element are used interchangeably, and a particular cell may be referred to by coordinate or by its unique cell identification integer, Cell_ID.

As shown, the overlaid map of FIG. 1B is a depiction of a two dimensional map of a geography. The geography map might be defined by a use case, or it might be provided by a third party (e.g. NavTeq or TeleAtlas). The map might be, and typically is represented as, a computer readable database (See Table 1), and the projection shown in the curvilinear features of FIG. 1B is but one of a multitude of possible two-dimensional projections of data found in the database.

Table 1 depicts a possible representation of a series of points of interest. As shown the dataset is structured in relations such that information regarding a point of interest, for example “ALBANY” might be retrieved directly from the row of the table (e.g. STREET, LANG, POP), or information regarding “ALBANY” might be retrieved indirectly from a separate relation (e.g. L_ID, POI_ID). Of course such information is not limited to the example given, and in fact many thousands of bytes of information are generally available in a geography map computer readable database.

Thus, given such a computer readable database containing at least enough information to overlay distances in at least one projection (e.g. county, other political boundaries, natural geographic features, etc) to the grid of FIG. 1A, it is then possible to depict the overlay of the geographic data onto the grid.

TABLE 1

| POI_NAME | L_ID | POI_ID | STREET | LANG | POP | NAT | COUNTY |
|---|---|---|---|---|---|---|---|
| ALBANY | 21,188,066 | 17,205,207 | 3RD AVE SW | ENG | 40,852 | N | WHYTE |
| DALLAS | 21,188,199 | 17,205,408 | 0R-223 | ENG | 12,459 | N | WHYTE |
| GREEN | 112,326,389 | 17,173,024 | UTE PASS | ENG | 773 | N | GRUEN |
| MTN FALLS | | | AVE | | | | |
| E.WACO | 41,475,395 | 17,195,646 | US-101 | ENG | 950 | N | KURO |
| CRESTON | 21,168,261 | 17,195,284 | US-2 | ENG | 232 | N | WHYTE |

Overlaying Geographic Boundaries and Features onto the Grid of an Influence Map

As shown, the overlay of FIG. 1B depicts the mapping (e.g. assignment) of geographic features of the geography map to the grid. Of course only a two-dimensional representation is shown on the pages herein, however it is well known to computer scientists that this is only one possible projection. In fact, so long as there is at least one way to map from a grid coordinate or Cell_ID to a corresponding point or area in the geography map, every aspect of that point or area found in the database can be assigned to, or at least imputed to belong to, that grid coordinate or cell. It must be emphasized that the database need not be, and typically is not organized as, strictly an array. In fact, although it might be permitted and convenient to address some data in the database via a coordinate, not all attribute(s) need be directly addressable by coordinate. For example, if a coordinate addressing scheme is used to identify the city name corresponding to that coordinate, then some other means (for example a lookup or join operation) might be performed to retrieve the name of the country in which that city is located. Of course this is but one example, and many other examples are used herein without further discussion of database retrieval methods as are known in the art.

Once the overlay has been represented in a computer-readable form, the grid cells are then cut/split into two or more sub-cells against any existing geographies. For example, a cell might be intersected by the border of a town's city limits, or against a hierarchically higher political/administrative boundary or against a postal sector, or against a geographic feature such as a river or other body of water. Of course it is possible that a grid cell or group of cells might be overlaid by non-commercial or explicitly excluded. Other exclusions might include merely uninteresting geographic areas such as a national preserve, or a country not being considered in the construction of the influence map, or an ocean, or any other characteristic that deems the point or area to be excluded from consideration in the construction of the influence map. In such cases, the corresponding grid cell or its constituent cut/split sub-cells can be nulled or otherwise removed from further consideration. Of course there might be situations (e.g. when mapping the boundary of a National Park) where one or more cells bordering or intersected by a boundary might initially be considered as a candidate to be nulled. However upon additional consideration (e.g. consideration of street geometry within the National Park) the cell might not be nulled, and thus be subject to further processing.

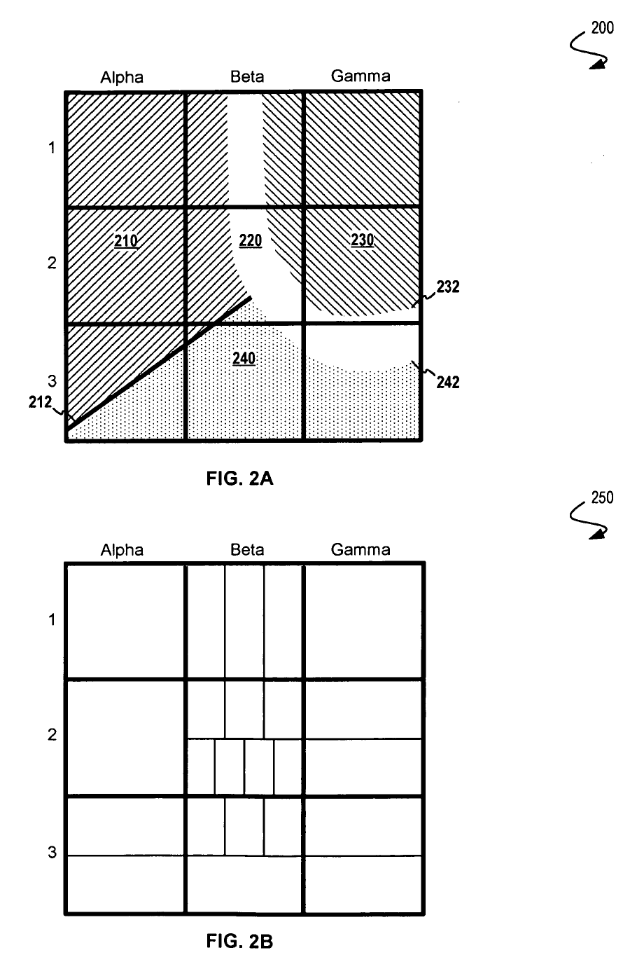

Inasmuch as we are concerned with a computer representation of an influence map, it might be convenient to represent points or areas by a unique identifier, possibly an integer. For example, as shown in the mapping of FIG. 2A, a group of nine cells contain a mapping of city centers for city 210, city 230, and city 240. In this exemplary case, some city boundaries are formed by the banks of a river 220. More precisely, the northeast riverbank 232 forms a city boundary for city 230, and the southwest riverbank 242 forms a city boundary for city 240 and city 210. As shown in FIG. 2A, only the city center is shown. A discussion follows describing techniques for propagating influence from a single point or an area representing city center to outlying areas.

### Performing Cell Splitting due to Geographic Boundaries or Features

Cell splitting into sub-cells may be performed using one or more techniques ranging from trivial to sophisticated. The technique presented herein takes advantage of the two-dimensional representation in that a single grid area may be cut/split into two or more rectilinear, non-concave, neighboring sub-cells. The area represented by the sum of the areas of the split cells is equal to the original cell before splitting. Continuing with the example shown in FIG. 2A, the area centered at coordinate Beta_1 can be described as having three sections, arranged from left to right (i.e. horizontally) as is shown in FIG. 2B. Continuing, the area centered at coordinate Beta_2 can be thought of as having a top part which is further divisible into three neighboring sections, and having a bottom part further divisible into four sections, hence the representation of the cell showing three horizontal sub-cells atop four horizontal sub-cells, as shown in FIG. 2B at coordinate Beta_2. Attributes of applying this technique include (1) a grid cell is divided into as few additional rectilinear sub-cells as is needed to roughly represent each boundary, (2) each new sub-cell created by the cut/split is assigned a new, unique Cell_ID, and (3) every sub-cell has a unambiguously identifiable set of adjacent cells (i.e. any bordering cell sharing at least one edge), each of which adjacent/neighboring cell's respective Cell_ID can be known or defined at the time of creation.

It should also be noted that this technique improves on other techniques that globally increase the resolution of cells.

In some embodiments, the additional, divided sub-cells may be represented as a pointer to a ‘sub-array’, or the additional new cells might be represented as a list for which the list head is the original, un-split cell, or the new cells might be represented as a row in a relation, and addressable by their unique Cell_IDs.

### Calculating Neighbors of Cells

Since every cell can be represented as a non-concave rectilinear cell, each and every one of its neighbors can be calculated and optionally stored in computer-readable format, possibly including storage in the form of a database relation.

The use of cell splitting allows a single grid area of dimension D to contain multiple sub-cells which, in aggregate, can then represent two or more influences. Additionally, the splitting of cells using the technique above allows every cell (though now split) to be associated in a one-to-one relationship with exactly one projection value (e.g. city or town), even though the original un-split cell may have been mapped to multiple projection values (e.g. the grid area contained at least a portion of two or more cities or towns).

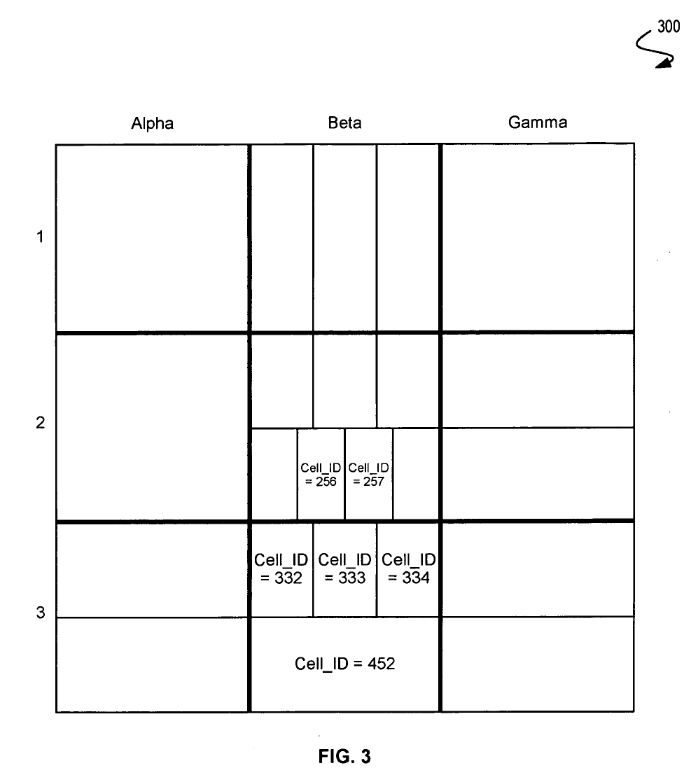

One such possible projection is the city or town name or other identification uniquely representing the city or town. In typical cases, a city or town or any other political division can be represented via a number, typically an integer, and thus unambiguously referenced and used in the retrieval of any other information found in any association or relation to that unique number. For example, comparing FIG. 2B and FIG. 3, the cell at Beta_2 in FIG. 2B has been split using the above technique and a subset of the split cells have been labeled. Selecting the split cell with Cell_ID=333 (strictly as an example), the relationship between the cell with Cell_ID=333 and its neighbors is depicted in Table 2 below.

TABLE 2

| Cell_ID | Cell_ID_Neighbor |
|---|---|
| 333 | 256 |
| 333 | 257 |
| 333 | 332 |
| 333 | 334 |
| 333 | 452 |

### Assigning Initial Influences

Continuing with operations for constructing the influence map, each cell in the influence map can now be tested against the geography map to determine if the geography map accords that area a particular influence (e.g. a town), and if so, accords that area a corresponding unique identifier (e.g. Town_ID). In some cases, the geography map database may not hold a Town_ID corresponding to a particular area. In such a case, the influence map cell remains unassigned. In the alternate case, the Town_ID is assigned to the influence map cell. It must be emphasized that regardless of whether the geography map contains location point data (i.e. a Town_ID located at exactly one point) or polygon data (i.e. a Town_ID assigned to an area), the Town_ID returned by the retrieval is assigned to the cell being tested. In cases of only point data being available, various sophisticated techniques (e.g. Voronoi tessellation) for propagation of a point over an area (e.g. the full area of the town to some propagation border) might be applied; however, such techniques are unnecessary for the practice of any method disclosed herein, and any cells not covered by point data may be left unassigned. In fact, even in the case where the geography database contains only point data, the propagation of city data to unassigned cells may be accomplished using techniques, disclosed farther below.

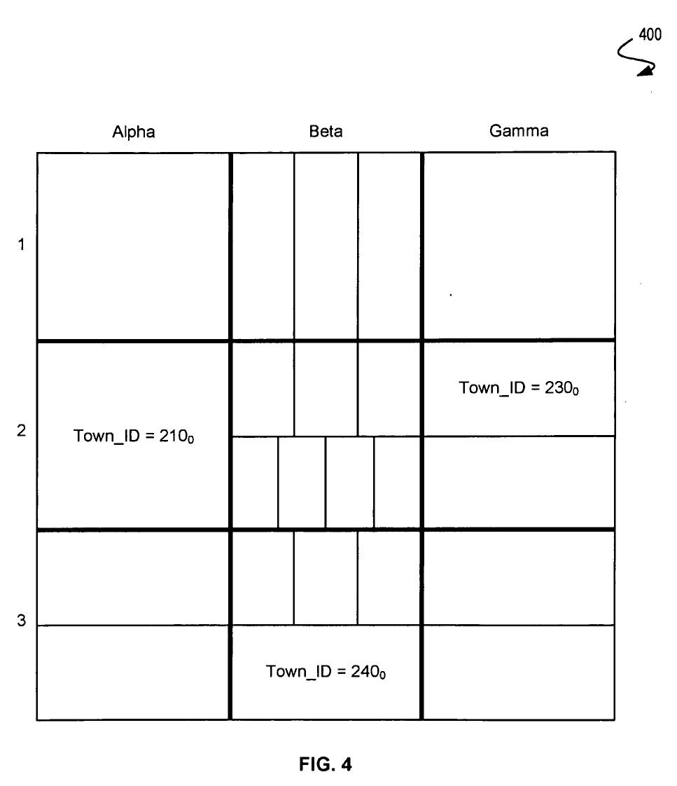

FIG. 4 shows the area of FIG. 2A mapped onto the split cells of FIG. 2B and with assignments of Town_IDs, namely 210₀, 230₀, and 240₀. In this purely exemplary case, the Town_IDs 210₀, 230₀, and 240₀ are mapped respectively to exactly one cell. In other cases or other embodiments a Town_ID might be assigned to any number of cells, based on the data (e.g. point data or polygon data) returned from the geographic map database. In particular, it is sometimes the case that a single named town might be situated in a concave area. It is also possible that a single named town might even be distributed throughout a plurality of non-contiguous areas (e.g. the non-contiguous areas having zero cell edges in common).

### Propagating Influences

The influence map is now in a condition for propagation of influences. In various embodiments, propagation of influences proceeds iteratively, each iteration including propagation from any assigned cell to any or all of its unassigned neighbor cells. The number of iterations increases in proportion to the number of unassigned cells. Throughout this disclosure, the iteration number is frequently referred to as the propagation value. In the figures of this disclosure, the propagation value is represented as a subscripted integer value (although any numeric value might be used in various embodiments). In other embodiments, the propagation value may be a function, possibly including the ordinal value of the iteration in addition to any number of other values of importance that permits calculation and comparison of the relative value of one propagation value to another.

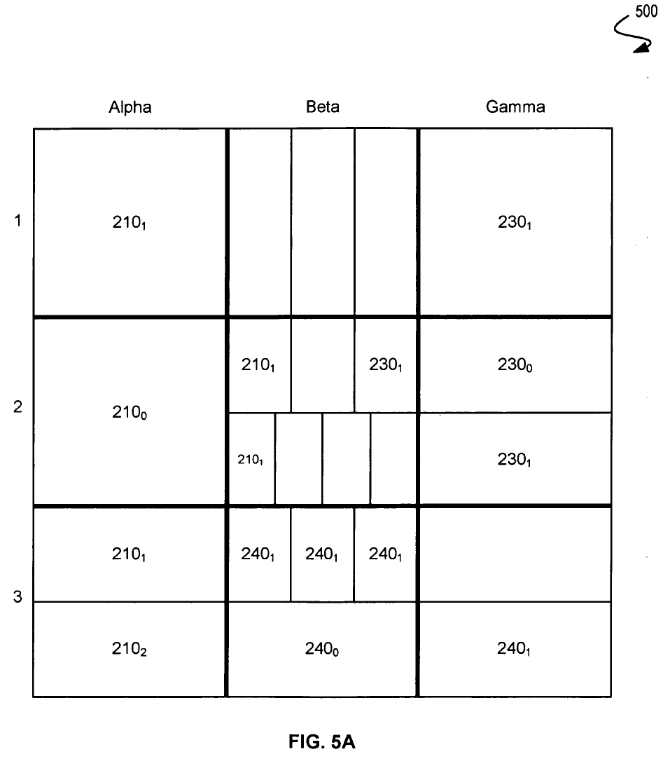

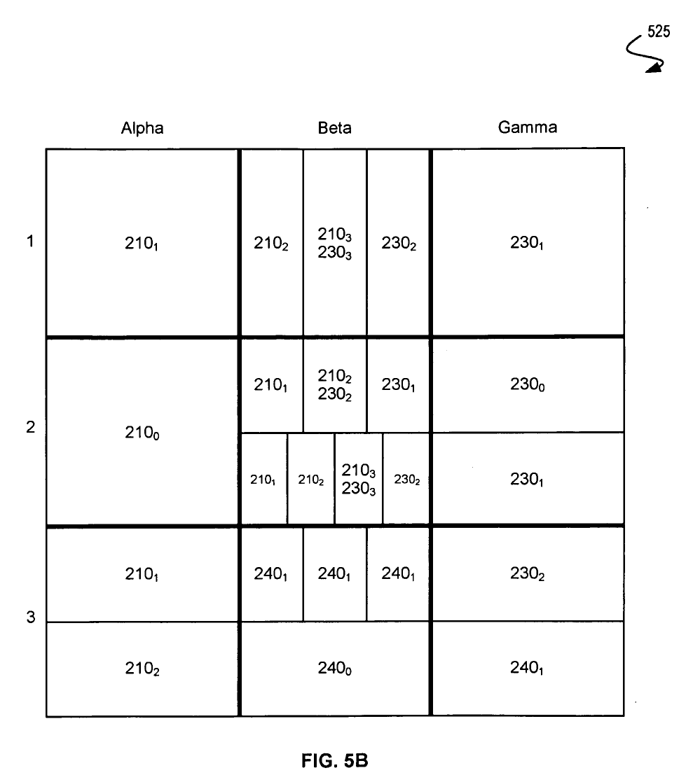

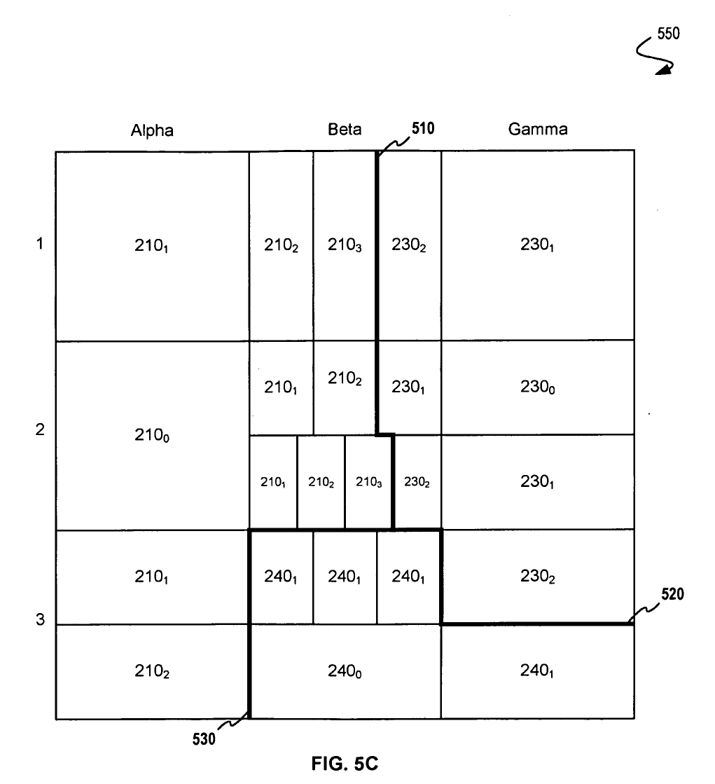

Continuing with the example as shown in FIG. 4, and referring to the initial influences of Town_IDs, namely 210₀, 230₀, and 240₀, the entire influence map may be completed in three iterations of influence propagation (not including the initial influence assignments of 210₀, 230₀, and 240₀). As shown in FIG. 5A, the first propagation iteration results in assignment of cells labeled 210₁, 230₁, and 240₁. The second iteration results in assignment of cells labeled 210₂, 230₂, and 240₂. Finally, as shown in FIG. 5B the third iteration results in assignment of all cells labeled 210₃, 230₃, and 240₃.

It can be noted that in some cases (typically at the borders of influence), the assignment of a particular cell might represent a tie. That is, the assigned value might take its influence from one propagated influence or another. In the example shown in FIG. 5B, such a situation is apparent for the cells labeled with multiple Town_IDs.

Of course those skilled in the art will immediately recognize that the various propagation techniques might be alternatively applied depending on the underlying data structure. In cases where the cells are being represented as an array, the iterations might propagate in a do while loop until there are no more cells remaining unassigned. In cases where the cells being represented are in a list or set, the iterations might propagate recursively on the remaining set of unassigned cells until there are no more remaining unassigned cells. In cases where the cells are being represented as one or more relations in a relational database, the iterations might propagate iteratively on the set of unassigned cells returned by a query until there are no more remaining unassigned cells returned in such a query.

Strictly as an example, and using the MapBasic language, the process of propagating a Town_ID found in a grid (a relation) into unpopulated cells is achieved by iteration over the following five lines of code.
1. Select * from Grid where Town_ID=0 into query1
2. Select * from neighbors where Town_ID< >0 and Town_ID_{—}2=0 into query2
3. Add Column “Query1” (Town_ID)From Query2 Set To Town_ID Where COL1=COL4
4. Add Column “neighbors” (Town_ID)From Grid Set To Town_ID Where COL1=COL1
5. Add Column “neighbors” (Town_ID_{—}2)From Grid Set To Town_ID Where COL4=COL1
   A step-wise description of these five lines of code is as follows:
1. Unpopulated cells are selected out as query1.
2. Records from the neighbors file that have a populated Town_ID, but their neighbors are not populated are selected out as query2.
3. Records in query1 are assigned a Town_ID from query2 where their Cell_ID is equal to the Cell_ID Neighbors of the blank neighbors in query2.
4 and 5. These Town_IDs are then relayed back to a master cell file, which propagates the Town_IDs outwards.

The five steps above are repeated until every cell is assigned a Town_ID.

Of course the use of the term “Town_ID” is only exemplary, and as indicated above, any attribute or attribute value might be projected onto the influence grid, and propagated as an influence. Again, although the example of FIG. 4 and FIG. 5A discussed only the propagation of the Town_ID influence, once an influence has been assigned to any cell, that cell might take on any other attribute or attribute values as may be present in the database, or in any other database for that matter, so long as there is a relation or function between the assigned influence and one or more attributes or attribute values. Applying this concept to our example, once a given cell is assigned a Town_ID, that cell could be populated with the attributes associated with the Town_ID, for example Town Name, Population, Parent State/County, etc. The population of one or more attributes or attribute values might include only an identifier, for example a town name, or the population might include assignment of a pointer to a data structure, or the population might be performed via an actual copy of one or more attribute values to the cell.

### Calculating Adjacencies

As one might have observed, using one of the techniques described above might produce one or more boundaries of influence that are different from the strict geographic boundaries (if any) that might have been provided in the geographic map dataset. Strictly as an option, such boundaries between two or more regions of influence can be calculated directly from an influence map in a condition as presented in FIG. 5B. By inspection of FIG. 5C, one might observe the synthetic boundaries 510, 520, and 530 formed by a shared edge where the Town_ID of two adjacent cells differ. Indeed, following the example of FIG. 5B, the borders are slightly different than those shown in the overlay of the geographic map features as shown in FIG. 5A. Of course in the example situation as shown in FIG. 5B the boundaries are similar to the boundaries of the corresponding geographic map of FIG. 2A; however this is not always the case. In fact, in situations where the center of influence (e.g. town center) is located near to a geographic boundary of the town area rather than near the geographic center of the town area, it is likely that the influence map boundaries will be drawn significantly differently than the geographic boundaries.

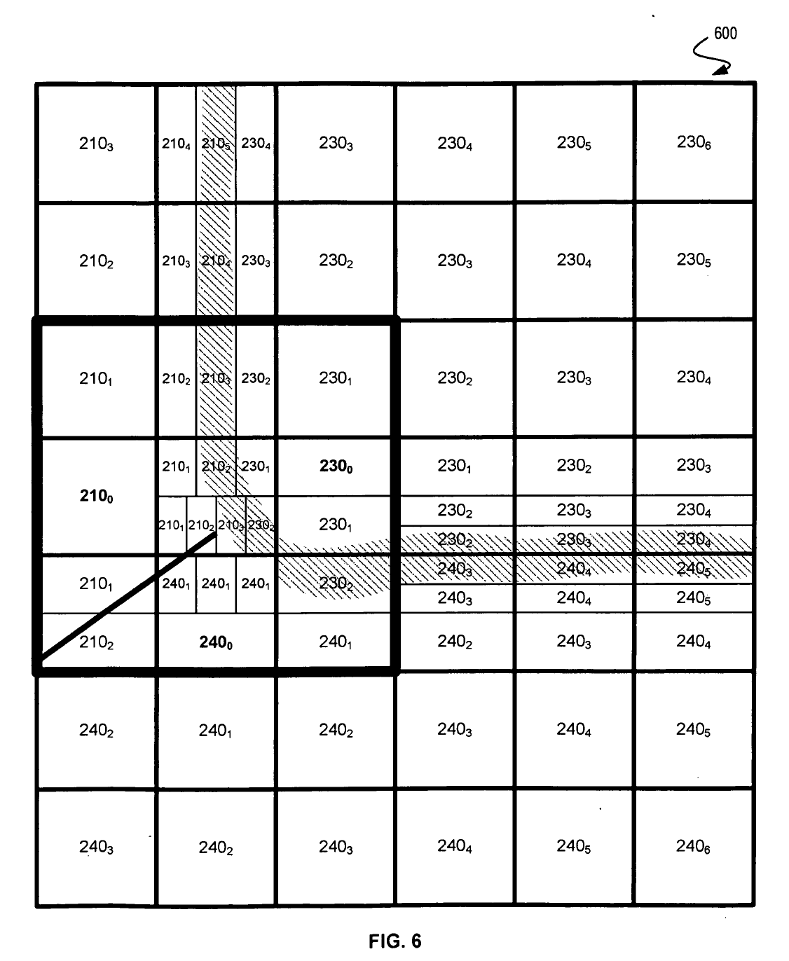

Still continuing with the example as shown in FIG. 4, and for purposes of providing a suitable example for discussion of techniques for adding a town, FIG. 6, shows a larger grid 600 as completed by using the propagation techniques discussed above, and with all cells assigned to exactly one influence. The bordered area is representative of the area shown in grid 400 of FIG. 4.

### Adding a Town

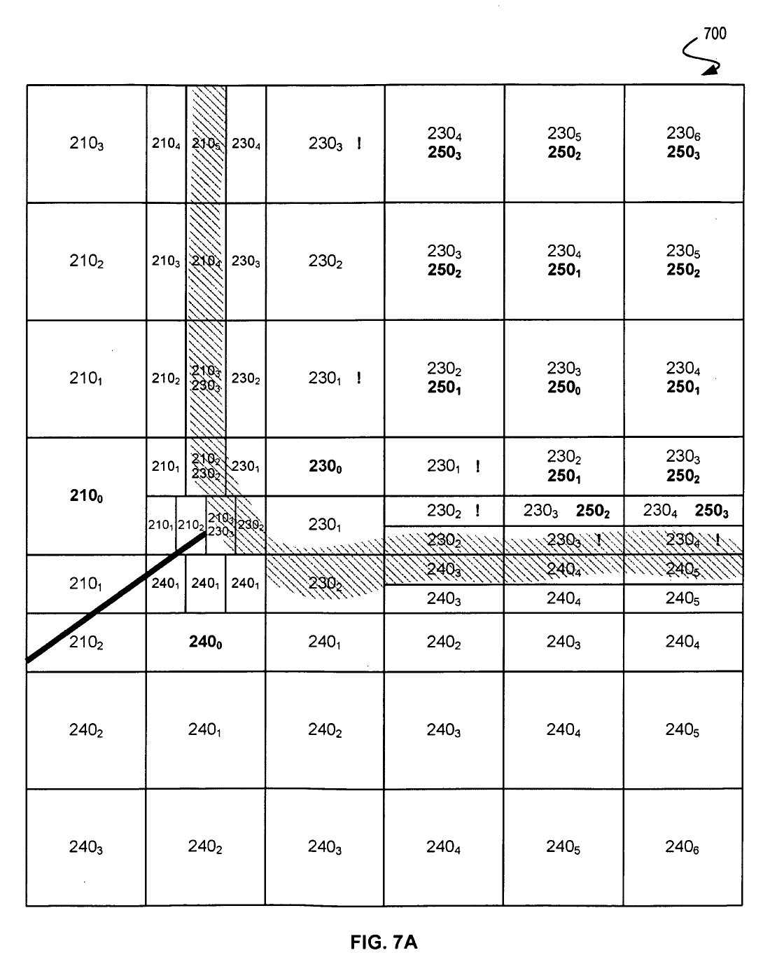

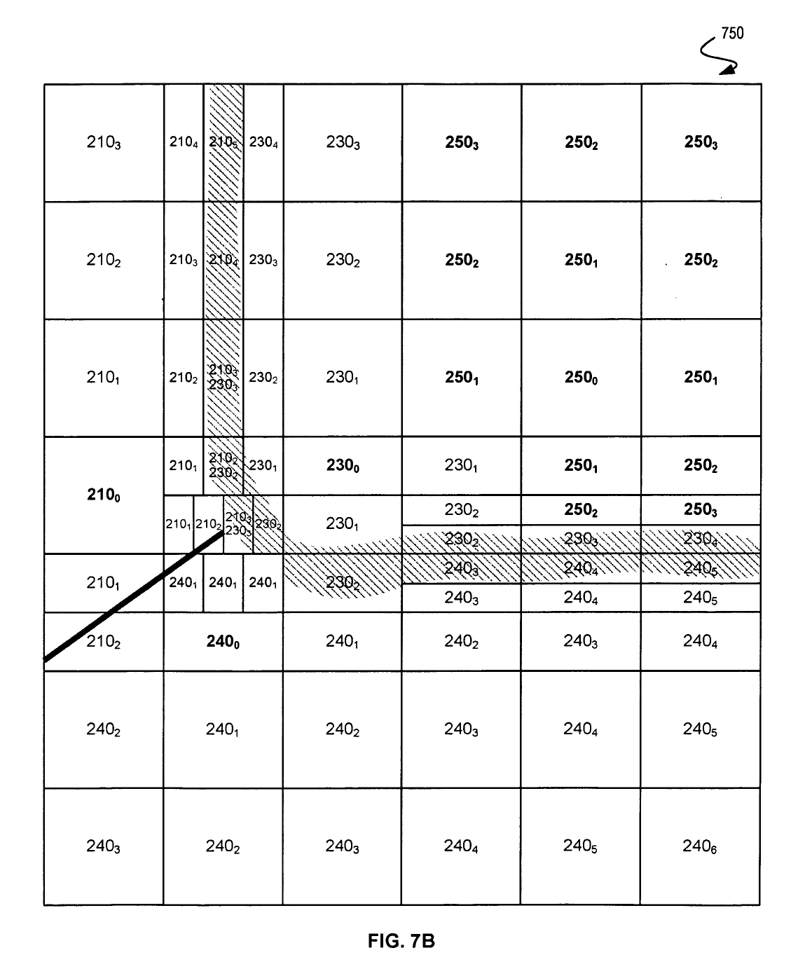

As time goes on, influences may change. For example, what was formerly a relatively uninhabited and/or for various reasons was formerly a relatively low influence point on the geography map might become sufficiently influential as to warrant an assignment of a Town_ID, and propagation of the Town_ID and its influence might need to be reflected on the influence map. In such a case the Town_ID is assigned to the cell (or cells) containing the point (or areas) of influence. Propagation continues as earlier described, except that propagation of an added Town_ID overwrites cells that have been previously assigned a lesser influence (i.e. a higher propagation value). For example, as shown in FIG. 7A, the point of influence 250₀ is propagated to its neighbors (see cells marked 250₁), and iteratively propagated to candidate neighboring cells marked 250₁ and so on only where the propagation value already present in the candidate neighboring cell has a lower influence (i.e. higher propagation value). In other words, if a candidate cell has a higher influence (to its corresponding Town_ID) than the influence of the newly populated Town_ID, then the Town_ID and propagation value for the candidate cell remains unchanged. In the depiction of FIG. 7A, the cells that will be assigned a new value are depicted with two Town_IDs in a single cell. The unchanged cells are annotated with an exclamation point (!).

It should also be noted that adding a town by using the just described method can be accomplished in O(P) operations where P is the number of cells changed by the addition of the town to the influence map. This can be contrasted with O(X*Y) operations in the case of application of earlier techniques. In general the difference is significant inasmuch as P is typically small (e.g. hundreds to thousands) relative to the product X*Y which is typically in the millions. A completed influence map after addition of the town with Town_ID 250 is shown in FIG. 7B.

### Flow Representation of Initial Propagation

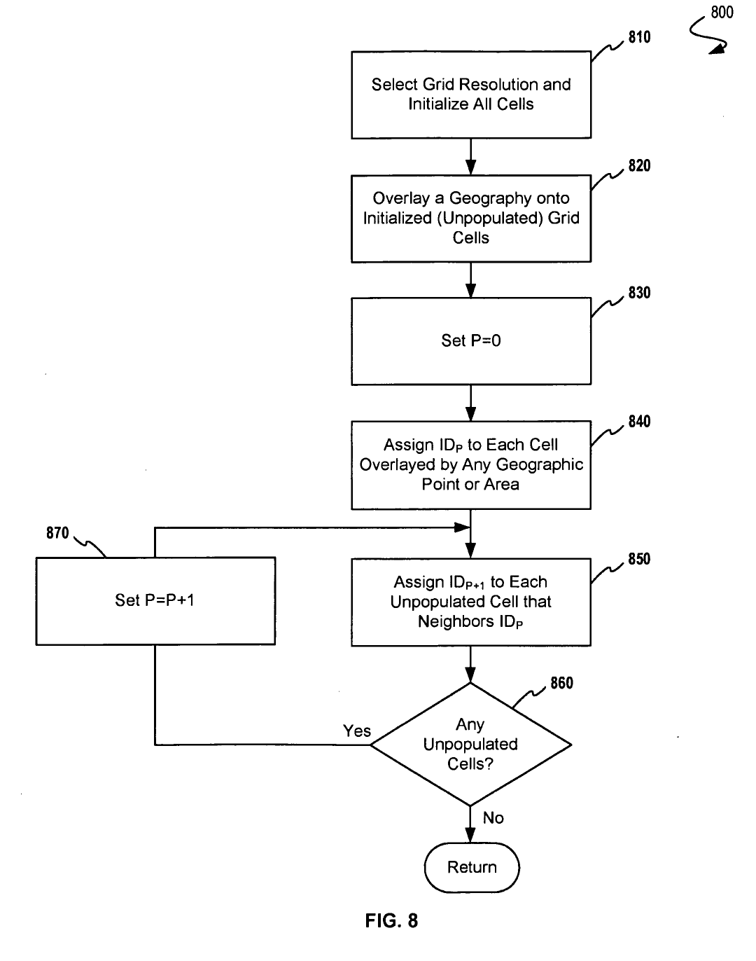

FIG. 8 depicts an embodiment of the invention using a flow diagram. In particular, steps and decisions for creating and populating a grid of cells include selecting a resolution for the grid of cells to be overlaid (see operation 810). When a grid is available and initialized, a geography map may then be overlaid. In this embodiment, cells that are overlaid by unmapped or uninteresting data may be nulled and thereby excluded from further processing. However, the cells that are assigned, for instance, to a particular land mass or country, or county or city or town or any other political, administrative or geographic feature, are then tagged to contain, or point to, at least one unique cell ID. In some cases, this overlay operation might proceed in a top-down hierarchical fashion (e.g. by tagging each cell overlaid by the selected hierarchy). Of course, depending on the characteristics of the geographic map data, such a hierarchy might not exist. Alternatively, a bottom-up approach is reasonable and contemplated; specifically, characteristics might be assigned to non-null cells using one or more characteristics from some lower-level hierarchy (see operation 820).

Continuing with the flow diagram, the iterations may begin. Strictly as an example, a propagation value P might be assigned an initial value (see operation 830). Of course in the context of this flow description, an iteration might be implemented using any number of computing techniques, including an iterative code control structure (e.g. a while loop), or it might be implemented as a recursive function call, or it might be implemented as a series of queries and writes to a database. In any of such implementation options, cells in the grid might be assigned an ID (e.g. a unique numeric value) and an iteration value P. A cell that is assigned an ID and a propagation value P is deemed to be a populated cell. Again, strictly as an example, and as indicated in the assignment of ID_{P} to a cell (as per operation 840), the iteration value might be simply an integer value representing the ordinality of the iteration.

Once all cells that are overlaid with geographic points of area data have been assigned (e.g. tagged), the iterations may commence and each unassigned cell U₀-Uₙ that neighbors an assigned cell C is then assigned the ID of cell C and is also assigned the propagation value P+1 (see operation 850). If, after execution of operation 850 there remains any un-populated cells, the propagation value P is incremented (see operation 870), and the flow proceeds again to operation 850. When there remain no more unpopulated, non-null cells in the grid, the flow returns to its caller (see decision 860).

### Flow Representation of Propagation of a New Influence

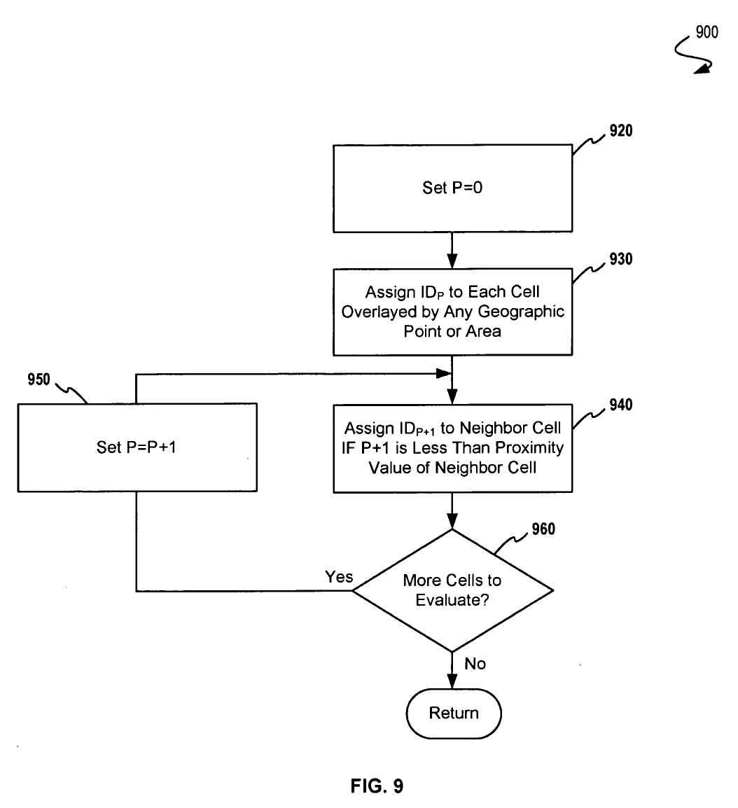

FIG. 9 depicts an embodiment of the invention using a flow diagram. In particular, FIG. 9 shows steps and decisions for adding a new influence (e.g. Town_ID) and revising the assignments of affected cells. Given a new geographic influence with its unique ID, all cells overlaid by the geographic influence are assigned ID_{P} where P is the propagation value (see operations 920 and 930). Any number of iterations may then proceed, assigning ID_{P+1} to neighboring cells only if the subject neighboring cell holds a proximity value lower than P (see operations 940, 950 and decision 960). When there are no more candidate neighbor cells, the flow returns to its caller.

### Flow Representation of Handling Removal of an Influence

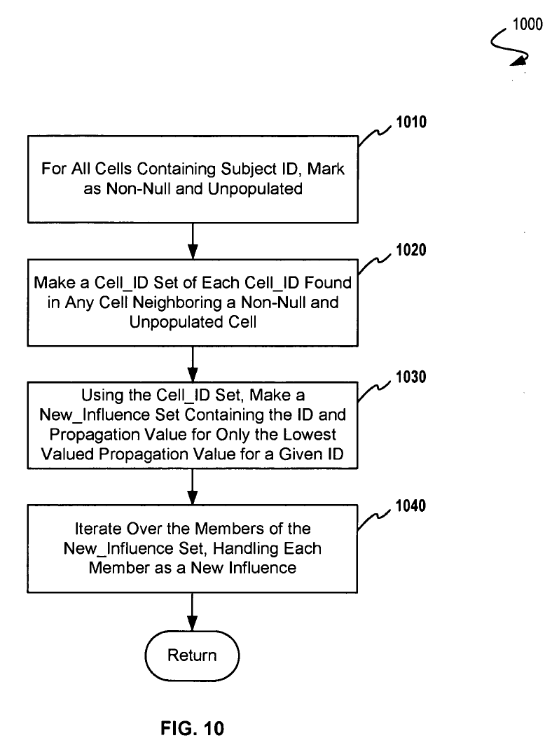

FIG. 10 depicts an embodiment of the invention using a flow diagram. In particular, FIG. 10 shows steps involved in the removal of an influence. Such a situation might arise for many reasons including errors being discovered in the geographic map database, or in a situation where a particular location is explicitly restricted in a manner such that its influence is to be eliminated.

The flow for removing an influence involves marking all cells containing the subject ID (e.g. Town_JD) of the influence to be removed) as non-null and un-populated (see operation 1010). Once the subject influence has thus been removed from any cell in the grid, a set containing all Cell_IDs at the borders of the just created un-populated area(s) is generated (see operation 1020). Using only the cells from the set created in operation 1020, a further set is created (see operation 1030) to contain only the strongest influences (e.g. ID and lowest numbered propagation value) together with that cell's Cell_ID. Having now a set that describes the same characteristics (e.g. an ID such as a Town_ID) of a new influence (see FIG. 9 and related discussions), and an indication of the location in the grid such as a Cell_ID, each member of the set may then be processed as if it were a new influence (see operation 1040).

### Use in On-Line Applications

As aforementioned, managing a vast range of products and services involves matching a user's search query with availability of advertised products and services that correspond to a particular geographic location of interest. Generally, an on-line advertiser will have one or more physical locations of possibly varying location types (e.g. within a mega-mall, within a supermarket, within a strip mall, etc), and generally such an on-line advertiser can be included in one or more advertiser types (e.g. food, lodging, apparel, auto repair, etc). The combination of, a user-specified geography of interest or even an inferred geography of interest (e.g. within one mile from my location, within one mile from city center, etc), combined with an influence map, provides information necessary to match relevant advertisements on the basis of an objective function of geography. Additional match criteria (e.g. advertiser type, location) might be (optionally) employed in determining a query for retrieving a result set of candidate advertisements based on the aforementioned match criteria. Of course the use of the database-centric terms ‘query’ and ‘result set’ are not intended to be limiting. In fact a query for retrieving a set of results might indeed be implemented as a relational database query (e.g. SQL), or a set might be retrieved by a subroutine, or by a function, or by a method or by use of other such techniques depending on implementation choices.

Once a set of advertisements from the query are returned, the set might be ranked based on various terms of relevance, including one or more influence values from an influence map (e.g. a propagation value from the influence map). The ranking might be presented to a user in a list form, or might be presented in a frame of a web page, or might be presented on a static map, or might even be presented as an interactive geographic map with controls such that a user might pan or zoom or otherwise navigate such a map.

### Displays

Using various techniques for display, an influence map showing polygon boundaries could be displayed for pan, rotate and zoom, and be used to analyze individual towns or a cluster of towns. From an advertiser's perspective, such a graphical display with interactive controls facilitates advertisers to select their desired town regions with a more granular and accurate representation of influences.

Similarly, in the context of social networking sites, instead of generating polygon boundaries from towns, a social network user's location could be used to generate selectable boundaries associated to that user with respect to other users in that vicinity, thus giving that user a sense of space and territory. Using one of a variety of graphical display devices, these boundaries could be clicked on to display user profiles, blogs, favorites etc. Moreover, a local search could utilize the generated polygon boundaries with a similar functionality to the aforementioned social networking example. Also in the context of social networking sites, a display might present selectable polygons that show local businesses and events when selected or otherwise triggered. For example if a user were to select their home town, a display might be presented showing (strictly for example) all coffee shops in all areas within a specified radius. Or more narrowly, a display might be presented showing only coffee shops in any area which holds an influence (e.g. propagation value) above some threshold.

### Network Environment for Influence Mapping System

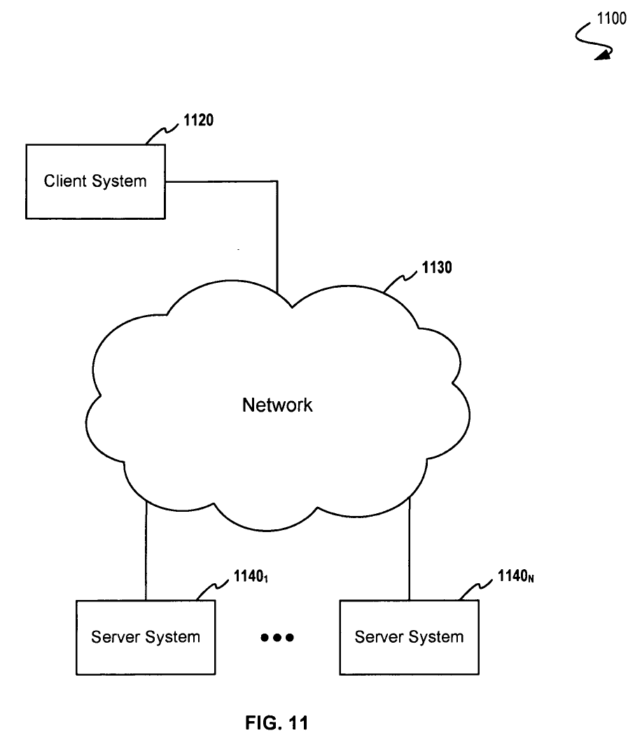

FIG. 11 illustrates one embodiment of a network environment 1100 for operation of the influence mapping system of the present invention. The network environment 1100 includes a client system 1120 coupled to a network 1130 (such as the Internet, an intranet, an extranet, a virtual private network, a non-TCP/IP based network, any LAN or WAN, or the like) and server systems 1140₁ to 1140_{N}. A server system may include a single server computer or a number of server computers. The client system 1120 is configured to communicate with any of server systems 1140₁ to 1140_{N}, for example, to request and receive base content and additional content (e.g. in the form of a web page).

The client system 1120 may include a desktop personal computer, workstation, laptop, PDA, cell phone, any wireless application protocol (WAP) enabled device, or any other device capable of communicating directly or indirectly to a network. The client system 1120 typically runs a web browsing program that allows a user of the client system 1120 to request and receive content from server systems 1140₁ to 1140_{N} over a network 1130. The client system 1120 typically includes one or more user interface devices (such as a keyboard, a mouse, a roller ball, a touch screen, a pen or the like) for interacting with a graphical user interface (GUI) of the web browser on a display (e.g. monitor screen, LCD display, etc.).

In some embodiments, the client system 1120 and/or system servers 1140₁ to 1140_{N} are configured to perform the methods described herein. The methods of some embodiments may be implemented in software or hardware configured to optimize the selection of additional content to be displayed to a user.

Various portions of the optimization system may reside in one or more servers (such as servers 1140₁ to 1140_{N}) and/or one or more client systems (such as client system 1120).

The influence mapping system may be implemented in either hardware or software. For the software implementation, the influence mapping system is software that includes a plurality of computer executable instructions for implementation on a general-purpose computer system. Prior to loading into a general-purpose computer system, the influence mapping system software may reside as encoded information on a computer readable medium, such as a magnetic floppy disk, magnetic tape, and compact disc read only memory (CD-ROM).

Although the present invention has been described in terms of specific exemplary embodiments, it will be appreciated that various modifications and alterations might be made by those skilled in the art without departing from the spirit and scope of the invention.

What is claimed is:

1. A method for presenting on-line advertising comprising:
determining a subject geographic location of interest;
determining a query for retrieving a result set of candidate advertisements based on at least two of said subject geographic location of interest, an influence map, an advertiser type;
ranking said result set using propagation values from said influence map; and
presenting said ranked result set.

2. The method of claim 1, further comprising:
overlaying geographic location data onto an XY grid of a plurality of cells;
dividing one or more of said cells into a plurality of sub-cells wherein said sub-cells overlay the same area as said one or more cells;
selecting some of said cells for assigning an ID based on the geographic location data;
propagating said ID and a propagation value to neighboring cells wherein said propagation value is increased over each of one or more iterations.

3. The method of claim 2 wherein said overlaying geographic location data onto an XY grid of cells includes a geographic location database.

4. The method of claim 2 wherein said overlaying geographic location data onto an XY grid of cells includes point data.

5. The method of claim 2 wherein said overlaying geographic location data onto an XY grid of cells includes area data.

6. The method of claim 2 wherein said dividing one or more of said cells into a plurality of sub-cells includes division based on one or more geographic features.

7. The method of claim 2 wherein said dividing includes division based on one or more political boundaries.

8. The method of claim 2 wherein said selecting includes selecting a single cell for containing a singular point provided in the geographic location data.

9. The method of claim 2 wherein said selecting includes selecting a group of cells for containing an area provided in the geographic location data.

10. The method of claim 2 wherein said propagating said ID and a propagation value to neighboring cells includes propagating only to non-null neighboring cells.

11. The method of claim 2 wherein said propagating said ID and a propagation value to neighboring cells includes propagating only to neighboring cells wholly contained within a predetermined geographic perimeter.

12. The method of claim 2 wherein said propagating said ID and a propagation value to neighboring cells includes propagating a first propagation value only to neighboring cells tagged with a second propagation that is value greater than said first propagation value.

13. A computer program product embodied on a tangible computer readable medium comprising:
computer code for overlaying geographic location data onto an XY grid of a plurality of cells;
computer code for dividing one or more of said cells into a plurality of sub-cells wherein said sub-cells overlay the same area as said one or more cells;
computer code for selecting some of said cells for assigning an ID based on the geographic location data;
computer code for propagating said ID and a propagation value to neighboring cells wherein said propagation value is increased over each of one or more iterations.

14. The computer program product of claim 13 wherein said execution unit for overlaying geographic location data onto an XY grid of cells includes said geographic location data includes a database.

15. The computer program product of claim 13 wherein said execution unit for overlaying geographic location data includes a point data.

16. The computer program product of claim 13 wherein said execution unit for dividing includes dividing into more than two sub-cells.

17. The computer program product of claim 13 wherein said execution unit for selecting some of said plurality of cells for assigning an ID based on the geographic location data includes selecting a single cell for containing a point provided in the geographic location data;

18. The computer program product of claim 13 wherein said execution unit for selecting some of said plurality of cells for assigning an ID based on the geographic location data includes selecting at least one cell for containing an area provided in the geographic location data;

19. The computer program product of claim 13 wherein said execution unit for propagating said ID and a propagation value to neighboring cells includes propagating a first propagation value only to neighboring cells tagged with a second propagation that is value greater than said first propagation value.

20. A system for presenting on-line advertising comprising:
computer code for determining a subject geographic location of interest;
computer code for determining a query for retrieving a result set of candidate advertisements based on at least two of said subject geographic location of interest, an influence map, an advertiser type;
computer code for ranking said result set using propagation values from said influence map; and
an apparatus for presenting said ranked result set.
